(19) United States
(12) Patent Application Publication
(10) Pub. No.: US 2021/0035556 A1
(43) Pub. Date: Feb. 4, 2021

(54) FINE-TUNING LANGUAGE MODELS FOR SUPERVISED LEARNING TASKS VIA DATASET PREPROCESSING

(71) Applicant: Babylon Partners Limited, London (GB)

(72) Inventors: April Tuesday SHEN, London (GB); Vitalii ZHELEZNIAK, London (GB); Francesco MORAMARCO, London (GB)

(21) Appl. No.: 16/530,050

(22) Filed: Aug. 2, 2019

(51) Int. Cl. G10L 15/06; G06N 20/00; G06K 9/62; G06N 3/08

(52) U.S. Cl. CPC G10L 15/063; G06N 20/00; G06K 9/626; G06N 3/088; G06K 9/6256

(57) ABSTRACT

This application provides systems and methods for training a language model to perform one or more specific natural language processing tasks. The embodiments described herein fine-tune language models for downstream tasks solely by pre-processing the training data set. Rather than fine-tuning via architecture changes (e.g., addition of classification layers on top of a language model), the embodiments described herein fine-tune language model(s) via dataset pre-processing alone. This is much simpler for the practitioner. Furthermore, it allows iterative additions of functionality to the language model without a complete restructure of the architecture. This is possible because of the general nature of the language-modelling task, which essentially consists of predicting what comes next in a sequence given some context. If training data can be framed in this manner, a language model can be used to solve that task directly without architecture modifications.

### TECHNICAL FIELD

The present disclosure relates to computer-implemented methods and systems for training a general language model to perform one or more specific natural language processing tasks, such as classification, intent recognition, sentiment analysis or inference. In particular, but without limitation, this disclosure relates processing training data to allow a pre-trained general language model to be trained via unsupervised training to perform a specific natural language classification task without changing or adjusting the architecture of the model.

### BACKGROUND

With the increased frequency of interactions between humans and computers, natural language processing is becoming an increasingly important part of designing a computing system. Natural language processing relates to the methods utilized by computing systems to interpret natural language data. Natural language data is data conferring natural language information, in that it is in the format of a language that has developed naturally through use (e.g., spoken language such as English) in contrast to formal language such as programming languages.

Many recent developments in natural language processing have made use of advances in machine learning. One drawback with machine learning is that it often requires a large amount of training data to train a model to perform a certain task. In addition, models trained for specific tasks are often unable to perform other tasks that fall outside of their initial training.

In light of the above, it is often necessary to train a new model for each new task. This can be very computationally expensive, as well as being time-intensive for developers. For instance, a developer may need to determine the most appropriate architecture for the natural language system for the given task (e.g., number and type of machine learning models, number of parameters, number of layers within each model, etc.). This may be required even if there has only been a slight alteration in the task being performed. For instance, a classifier may be trained to identify three classes. If a fourth class needs to be added, it may be necessary to adjust the architecture of the model and, potentially, train a new model from scratch. This can be very computationally expensive.

This can be exacerbated by the potential need for the engineer to test multiple different architectures to determine which is the most effective.

### SUMMARY

Embodiments described herein allow a language model to be fine-tuned to perform a specific task without architecture changes through processing of training data.

According to an aspect, there is provided a computer-implemented method for training a language model to perform one or more specific natural language processing tasks, the method comprising: obtaining a language model configured to assign probabilities to collections of words; obtaining a natural language training data set comprising training inputs and corresponding training outputs, wherein each training output represents a result of a mapping from a corresponding input via a corresponding task of one or more natural language processing tasks; combining each training input with its corresponding training output and a task trigger representing its corresponding task to form a set of processed training inputs; and training the language model to perform the one or more natural language processing tasks, wherein the training produces an updated language model configured to perform any one of the one or more natural language processing tasks to predict an output through processing of an input and the task trigger for the one of the one or more natural language processing tasks, wherein the training applies unsupervised learning to the set of processed training inputs to update weights of the language model.

By processing training data to include inputs, outputs and task trigger(s), language models may be trained to predict outputs when prompted by an input and a task trigger. This leverages the ability of language models to make accurate predictions for continuations of sequences of tokens (e.g., words). Importantly, this is achieved without changing the architecture of the language model or the training method, avoiding the computationally expensive and time-consuming process of redesigning the architecture of the system for the new functionality. In addition, it allows the model to be easily updated iteratively without requiring a complete restructuring of the system.

A task trigger may be any string or token that uniquely identifies the task being trained. The task trigger provides an indication to the language model that it is to predict an output.

According to an embodiment, the training does not adjust the architecture of the language model such that the updated language model has the same architecture as the language model. The training may instead simply update (fine-tune) the weights of the language model. The language model may be a neural network that models a probability distribution over sequences of tokens. A token may be a word, a symbol (such as for punctuation), or any other string that is specified in a dictionary (or vocabulary) for the language model.

According to an embodiment, combining each training input with its corresponding training output and a task trigger representing its corresponding task comprises, for each training input, concatenating the training input, the task trigger representing the corresponding task and the corresponding training output.

According to an embodiment, the task trigger is concatenated to the end of the training input, and the corresponding training output is concatenated to the end of the task trigger.

According to an embodiment, the one or more natural language processing tasks are one or more classification tasks and the training outputs set are labels for corresponding training inputs in the natural language training data set. The one or more natural language processing tasks may comprise one or more of a sentiment analysis task, an intent recognition task and an inference task.

According to an embodiment, the method further comprises training the updated language model to perform one or more further tasks. This comprises: obtaining a further training data set comprising further training inputs and corresponding further training outputs, wherein each output represents a result of a mapping from a corresponding training input via a corresponding further task of the one or more further tasks; combining each further training input with its corresponding further training output and a further task trigger representing its corresponding further task to form a further set of processed training inputs; and training the updated language model to perform the one or more further tasks. The training produces a further updated language model configured to perform any one of the one or more further tasks to predict an output through processing of an input and the task trigger for one of the one or more further tasks, wherein the training of the updated language model applies unsupervised learning to the further set of processed training inputs to further update weights of the updated language model.

According to an embodiment, the one or more natural language tasks and the one or more further tasks are classification tasks that differ from each other. That is, the classification tasks may classify between differing sets of classes.

According to an embodiment, the one or more natural language tasks comprise multiple tasks. That is, training the language model to perform the one or more natural language processing tasks may comprise training the model to perform multiple tasks. In this case, the natural language training data set may comprise multiple sets of training data, with each set of training data comprising training inputs and corresponding training outputs, wherein each training output within the set represents a result of a mapping from a corresponding input via a corresponding task for the set. Each set may be processed through concatenation with its corresponding task trigger.

According to an embodiment, the natural language training data set comprises sets of multiple training inputs, each set of multiple training inputs having a corresponding training output representing a result of a mapping from the set of multiple training inputs via a corresponding multiple input task of the one or more natural language processing tasks. Combining each training input with its corresponding training output and a task trigger comprises, for each set of multiple training inputs, forming a delimited training input by inserting a delimiter tag between each adjoining pair of training inputs in the set of multiple training inputs and combining the delimited training input with the corresponding training output and a multiple input task trigger representing the multiple input task. The training produces an updated language model that is configured to perform the multiple input task to predict an output through processing of a delimited input and a multiple input task trigger, the delimited input comprising multiple inputs with a delimiter tag separating each adjoining pair of inputs. Accordingly, delimiters may be used to separate multiple inputs, where multiple inputs are required for the task being trained. A delimiter may be any string or token that uniquely identifies a delimitation between inputs. In one embodiment, one or more of the training inputs in the training data set may be delimited inputs comprising multiple sub-inputs with a delimiter separating each sub-input.

According to an embodiment, the natural language training data set comprises sets of multiple training outputs, each set of multiple training outputs representing a result of a mapping from a corresponding input via a corresponding multiple output task of the one or more natural language processing tasks. Combining each training input with its corresponding training output and a task trigger comprises, for each set of multiple training outputs, forming a delimited training output by inserting a delimiter tag between each adjoining pair of training outputs in the set of multiple training outputs and combining the delimited training output with the corresponding training input and a multiple output task trigger representing the multiple output task. The training produces an updated language model that is configured to perform the multiple output task to predict a delimited output through processing of an input and a multiple output task trigger, the delimited outputs comprising multiple outputs with a delimiter tag separating each adjoining pair of inputs. Accordingly, delimiters may be used to separate multiple outputs, where the task being trained produces multiple outputs. A delimiter may be any string or token that uniquely identifies a delimitation between outputs. In one embodiment, the language model may be trained to perform a multiple-input and multiple-output task, using delimiters in both the inputs and outputs. In one embodiment, one or more of the training outputs in the training data set may be delimited outputs comprising multiple sub-outputs with a delimiter separating each sub-output.

According to an embodiment, the method comprises: receiving an input for processing by the updated language model; obtaining a task trigger representing a task to be performed on the input; combining the input with the task trigger to produce a processed input; determining a prediction for an output in accordance with the task to be performed on the input by inputting the processed input into the updated language model; and outputting the predicted output.

Accordingly, once trained, the updated language model may be utilized to perform one of the one or more natural language tasks through application of the updated language model to a combination of an input and a task trigger.

According to an embodiment, determining the prediction for the output comprises: inputting the processed input into the updated language model to obtain a set of probabilities, each probability representing a probability of a corresponding token following the processed input; and selecting the predicted output based on the set of probabilities.

A token can be considered a potential string according to a predefined dictionary. This can include words and strings of one or more characters, such as punctuation. The method may select the most probable output (most probable token) based on the set of probabilities. This may be the most probable individual token.

According to an embodiment, the set of probabilities comprises a probability for each token in a predefined dictionary. Determining the prediction for the output further comprises extracting a subset of the set of probabilities, the subset including a probability for each of a set of expected outputs for the task. The predicted output is selected based on the subset. By selecting the output based on the subset, the output can be considered to be constrained to the set of expected outputs. This can help to avoid errors through the introduction of noise.

According to an aspect, there is provided a computer-implemented method for performing a natural language processing task to map an input onto an output, the method comprising: obtaining a language model configured to perform a natural language processing task to predict an output through processing of an input and a task trigger representing the natural language processing task; receiving an input for processing by the language model; obtaining the task trigger representing the natural language task; combining the input with the task trigger to produce a processed input; determining a prediction for an output in accordance with the natural language task by inputting the processed input into the language model; and outputting the predicted output.

According to an embodiment, determining the prediction for the output comprises: inputting the processed input into the language model to obtain a set of probabilities, each probability representing a probability of a corresponding token following the processed input; and selecting the predicted output based on the set of probabilities.

According to an embodiment, the set of probabilities comprises a probability for each token in a predefined dictionary. Determining the prediction for the output further comprises extracting a subset of the set of probabilities, the subset including a probability for each of a set of expected outputs for the task. The predicted output is selected based on the subset.

According to an aspect, there is provided a natural language processing system comprising one or more processors configured to: obtain a language model configured to assign probabilities to collections of words; obtain a natural language training data set comprising training inputs and corresponding training outputs, wherein each training output represents a result of a mapping from a corresponding input via a corresponding task of one or more natural language processing tasks; combine each training input with its corresponding training output and a task trigger representing its corresponding task to form a set of processed training inputs; and train the language model to perform the one or more natural language processing tasks, wherein the training produces an updated language model configured to perform any one of the one or more natural language processing tasks to predict an output through processing of an input and the task trigger for the one of the one or more natural language processing tasks, wherein the training applies unsupervised learning to the set of processed training inputs to update weights of the language model.

According to an aspect, there is provided a non-transient computer-readable medium containing programming instructions that, when executed by a computer, cause the computer to: obtain a language model configured to assign probabilities to collections of words; obtain a natural language training data set comprising training inputs and corresponding training outputs, wherein each training output represents a result of a mapping from a corresponding input via a corresponding task of one or more natural language processing tasks; combine each training input with its corresponding training output and a task trigger representing its corresponding task to form a set of processed training inputs; and train the language model to perform the one or more natural language processing tasks, wherein the training produces an updated language model configured to perform any one of the one or more natural language processing tasks to predict an output through processing of an input and the task trigger for one of the one or more natural language processing tasks, wherein the training applies unsupervised learning to the set of processed training inputs to update weights of the language model.

According to an aspect, there is provided a natural language processing system for performing a natural language processing task to map an input onto an output, the system comprising one or more processors configured to: obtain a language model configured to perform a natural language processing task to predict an output through processing of an input and a task trigger representing the natural language processing task; receive an input for processing by the language model; obtain the task trigger representing the natural language task; combine the input with the task trigger to produce a processed input; determine a prediction for an output in accordance with the natural language task by inputting the processed input into the language model; and output the predicted output.

According to an aspect, there is provided a non-transient computer-readable medium containing programming instructions that, when executed by a computer, cause the computer to: obtain a language model configured to perform a natural language processing task to predict an output through processing of an input and a task trigger representing the natural language processing task; receive an input for processing by the language model; obtain the task trigger representing the natural language task; combine the input with the task trigger to produce a processed input; determine a prediction for an output in accordance with the natural language task by inputting the processed input into the language model; and output the predicted output.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a method of predicting one or more subsequent words based a set of one or more input words;

FIG. 2 shows a method for training a language model to perform a specific task in accordance with an embodiment;

FIG. 3 shows a method for predicting an output based on an input using a language model trained using the method of FIG. 2; and

FIG. 4 shows a computing system for implementing the methods described herein.

### DETAILED DESCRIPTION

In light of the above, there is a need for a more efficient method of training a natural language model to performing a specific natural language processing task.

The methods described herein provide a more efficient means of training a system to perform a natural language processing task by adapting pre-trained language models to the specific task through unsupervised training on specifically processed training data. No adaptations to the architecture of the language model are required, thereby avoiding the labor and computation intensive process of designing and testing different architectures. Furthermore, as the system builds on knowledge learned by the language model (i.e., by fine-tuning the weights of the model), rather than completely training a new system, an accurate system can be obtained with relatively little additional processing (relative to training a new system from scratch). Furthermore, additional functionality can be added to the system without requiring architecture changes or the additional processing required to train a completely new system.

Language models (otherwise known as statistical language models) make use of probability distributions over sequences of words. A language model is therefore able to estimate the relative likelihood of a set of words. This is useful in many different natural language applications, such as speech recognition, translation or information retrieval. Language models are also able to determine the most likely word (or words) to follow a particular input set of words.

Language models can be trained through unsupervised learning applied to natural language text. This is important, as it avoids the costly and time-consuming process of labelling training data. Accordingly, very accurate language models can be obtained through training on large amounts of unlabeled natural language data (such as webpages, books, publications, etc.).

Importantly, whilst language models are trained to perform the general task of determining the likelihood of a set of words, many of the features learned through unsupervised training encode knowledge that can be utilized for more specific tasks (such as classification), provided that the system has been trained on a sufficiently large data set. These tasks often require specifically trained models (potentially via supervised training).

The embodiments described herein fine-tune language models for downstream tasks solely by pre-processing the training dataset, in contrast to alternative methods that fine-tune by training a separate model or applying generic language models directly to the downstream task without fine-tuning. This can be applied to any supervised language task, such as intent recognition or sentiment analysis.

Rather than fine-tuning via architecture changes (e.g., addition of classification layers on top of a language model), the embodiments described herein fine-tune language model(s) via dataset pre-processing alone. This is much simpler for the practitioner. Furthermore, it allows iterative additions of functionality to the language model without a complete restructure of the architecture. This is possible because of the general nature of the language-modelling task, which essentially consists of predicting what comes next in a sequence given some context. If training data can be framed in this manner, a language model can be used to solve that task directly, without architecture modifications.

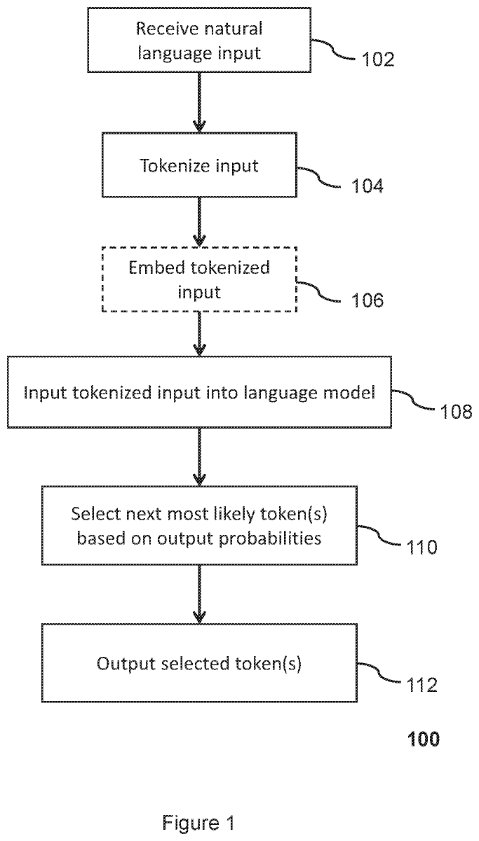

FIG. 1 shows a method of predicting one or more subsequent words based a set of one or more input words.

Firstly, a natural language input is received 102 in the form of a set of one or more input words.

The input is then tokenized 104. That is, the input is separated into its constituent parts (tokens). The method of tokenization may depend on the language model being utilized. Some language models consider text at the word-level, and therefore, the tokenization separates the input into its constituent words. Equally, some language models operate on the character-level so the tokenization may separate the input into its constituent characters. Alternatively, byte-pair encoding may be utilized, that replaces the most frequent pairs of bytes with identifiers (corresponding single, unused bytes). Each token may be a potential string that relates to a useful semantic grouping or unit within the input. This may be an individual word or punctuation from the input. For instance, the input “I have a headache” would be separated into the following tokens “I”, “have”, “a” and “headache”. Similarly, “Where does it hurt?” would become the tokens “Where”, “does”, “it”, “hurt” and “?”. Each token may be represented as a one-hot encoded vector. Such a vector would have a single feature for each potential token in the overall vocabulary (or dictionary) of the system. Different languages may be mapped onto different feature spaces representing different vocabularies.

The tokenized input (the set of tokens) may then be embedded 106. That is, each token may be mapped onto an embedding space to determine a corresponding embedding vector. Embedding can make the subsequent natural language processing steps more efficient, as each embedding encodes various natural language features of the token. This step is optional (as represented by the dashed lines in FIG. 1).

The tokenized (and potentially embedded) input is then input into the language model 108. The input provides the context for the prediction by the model. The language model determines a set of probabilities for one or more tokens to follow the input. This may be output in the form of a vector with a probability value for each potential token in the vocabulary for the system. That is, for each token in the vocabulary (i.e., each potential string in the vocabulary) a probability is determined representing the probability of that token being the next token to follow the input.

The system then selects a prediction for the next token based on the output probabilities 110. This may be the token that has the highest probability and is therefore the most likely to follow the input. This selection may then be output 112. Where embedded tokens are utilized, the output is decoded to determine the token for the selected embedded token.

Where multiple tokens (e.g., multiple subsequent words) are being predicted, the system may apply different methods for selecting these tokens. A greedy approach may be taken where the most probable token (the token with the highest probability) is selected each time and then fed back into the language model (added to the end of the input) to predict the next token in the sequence. Alternatively, the most probable overall sequence of tokens may be determined based on a combination of probabilities across multiple steps (such as through a beam search method). Either way, the result is a set of one or more tokens that are predicted to be the most probable next token(s) in the series.

A language model may be trained based on an unsupervised natural language data set comprising sets of tokens U={uᵢ, . . . , uₙ} via a language modeling objective to maximize the following likelihood:

$${L}_{1} ( U ) = {\sum }_{i} log P ( {u}_{i} \vert {u}_{i - k} , … , {u}_{i - 1} ; Θ )$$

where k is the size of the context window (the number of tokens provided as context/input for the model), and the probability P is modeled using a neural network with parameters Θ. These parameters are updated when training the model. The training may be any suitable training method, such as stochastic gradient descent.

As discussed above, the embodiments described herein provide the functionality of specific tasks that traditionally require supervised learning (such as classification) without architecture changes and by applying unsupervised learning. This is achieved through a specific method of processing training data. Once the training data is processed, the language model can be trained on the processed training data using unsupervised learning, potentially using the same training techniques (e.g., using the same objective function) as were used when training the initial language model.

Broadly speaking, the processed data set comprises the text input (the original training observation), a special textual trigger of some kind, and then the desired output (e.g., a label for the training observation). The inputs, trigger(s) and outputs can be represented by vectors. These vectors might be embeddings.

After training on this processed dataset, the system is able to perform the specifically trained task by inputting an input (a set of text) and a trigger and letting the language model predict what should come next. As the model has been trained based on training data that includes input, trigger and output, the model predicts an output for the input when prompted by the trigger.

This method also makes multitask learning relatively straightforward, as a combined data set (relating to multiple different tasks) can be created relatively easily for use in training multiple tasks efficiently in one iteration of training. There is no need to add multiple task-specific layers or change the objective function of the model.

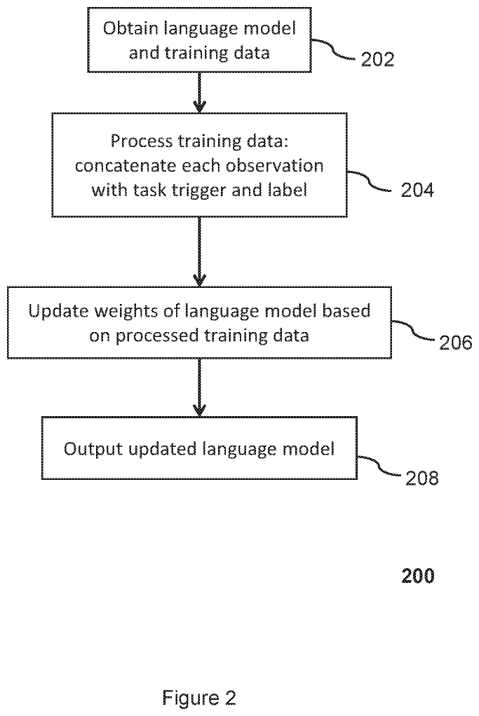

FIG. 2 shows a method for training a language model to perform a specific task in accordance with an embodiment.

The method begins by obtaining a language model and training data 202. The language model may be pre-trained on natural language data not specific to the task at hand. Alternatively, the system may train the language model itself based on generic training data (a set of unlabeled natural language text). Any language model may be utilized, provided that it is able to predict text that is to follow an input set of text. For instance, the GPT-2 language model from Open AI may be utilized.

The training data received is labelled training data suitable for supervised learning to train the system to perform the specific task required. This task may be any supervised learning task, such as any classification task (e.g., sentiment analysis, intent recognition or inference). Accordingly, the training data includes labelled observations, each including an observation (a set of text for input) and a label (an appropriate output according to the specific task).

The training data is then processed to form processed training data suitable for unsupervised training 204.

Given some task with some supervised dataset of (input, output) pairs, the method produces a dataset suitable for language modelling by, for each pair of input and output, concatenating the input with a task trigger corresponding to the task (the task linking the input and output) and the output for the input (in that order). That is, the task trigger is concatenated to the end of the input and the output is concatenated to the end of the task trigger. This forms a processed observation.

For example, if the task is sentiment classification (with a task trigger of “<sentiment>”), and one input is “This movie is terrible” with a label (output) of “negative”, the method produces the below processed observation:

“The movie is terrible <sentiment> negative”

Some tasks require ordered tuples of inputs, for example logical inference tasks. For these, a delimiter is utilised to separate the inputs. For example, for an inference task (with task trigger “<inference>”) with inputs “The boy is walking his dog” and “The boy is walking” and an output of “entailment”, the method produces:

“The boy is walking his dog <pair> The boy is walking <inference> entailment”

Wherein “<pair>” is a delimiter separating the two inputs.

Any number of inputs may be utilized, depending on the task, utilizing this delimitation method. In this case, a delimiter is inserted between each pair of inputs within the set of inputs. The resulting delimited input is an ordered concatenation of inputs and delimiter(s). This results in a delimited input that alternates between inputs and delimiter(s).

Equally, multiple outputs can be trained, making use of a corresponding delimiter. This requires multiple labels to be provided with each observation (or set of observations, where multiple inputs are used). The delimiter for the outputs may be the same as that used for the input or may be different so that it uniquely identifies output delimitations from input delimitations.

For instance, a multilabel classification task could be multiple intent recognition (without sentence segmentation). If the input is “I have a headache and would like a consultation”, this may be provided with multiple intent labels (intent having a task trigger of <intent>) separated by a delimiter (<sep> in this case). In this case, two outputs of “triage” and “booking” are provided:

“I have a headache and would like a consultation <intent> triage <sep> booking”

Accordingly, multiple outputs may be separated by a delimiter. Having said this, multiple output labels may instead be combined into a single more specific label. In the above example, this would produce an output of “triage booking”:

“I have a headache and would like a consultation <intent> triage booking”

Nevertheless, the separation of multiple outputs can be advantageous when processing the output, particularly where the output labels are relatively unrelated.

The precise formulation of the task trigger, delimiter and labels can vary. Any string may be utilized for the trigger, delimiter or label, provided that they uniquely identify their relevant concepts. For instance, the trigger needs to uniquely identify the task being trained, the delimiter needs to uniquely identify a delimitation (a separation between two or more inputs or two or more outputs) and the label (output) needs to uniquely identify the output for that task based on the input. The input(s), trigger(s), output(s) and delimiter(s) may be encoded as vectors (e.g., embedded vectors or one-hot encoded vectors). The triggers, delimiters or labels need not be unique tokens or sequences of tokens (they may also be potential tokens within the input) but must be unique relative to each other. For instance, in sentiment analysis, two potential labels of “positive” or “negative” may be utilized, as they are distinct from each other, even though the tokens “positive” and “negative” might also be tokens within the input (e.g., “I had a positive experience”).

In addition to the above, multiple tasks may be trained at the same time through the addition of multiple sets of training data. This simply includes additional task triggers, one for each task, and labelled observations corresponding to the required tasks.

When processing the training data, the task trigger may be preconfigured (e.g., stored and accessed from memory where the task is already know) or may be input or selected by the user. For instance, the corresponding task trigger(s) may be received at the same time as the labelled training data is received.

Once the processed training data has been produced, the language model is trained based on the processed training data 206. That is, the weights of the language model are updated based on an objective function applied to the processed training data. General unsupervised training can be used. The method for updating the weights of the language model may be the same as that used to train the initial language model. The only difference in this case is the training data. As the training data has been encoded with the task trigger(s) and outputs, the model learns to predict outputs when prompted with an input (or delimited inputs) and a task trigger.

Once trained, the updated language model is output 208. The language model may be stored (either locally or remotely). Alternatively, or in addition, the language model may be utilized immediately to perform the trained task.

To add additional functionality to the fine-tuned model, the model can be trained using additional training data in the same manner as that shown in FIG. 2; however, instead of updating the weights for a general language model, the weights of the fine-tuned language model is updated based on training data relating to a new task (and having a corresponding new task trigger).

Given a fine-tuned model produced from the training method above (see FIG. 2), this can be used to predict outputs for novel (unlabelled) inputs by providing the appropriate trigger.

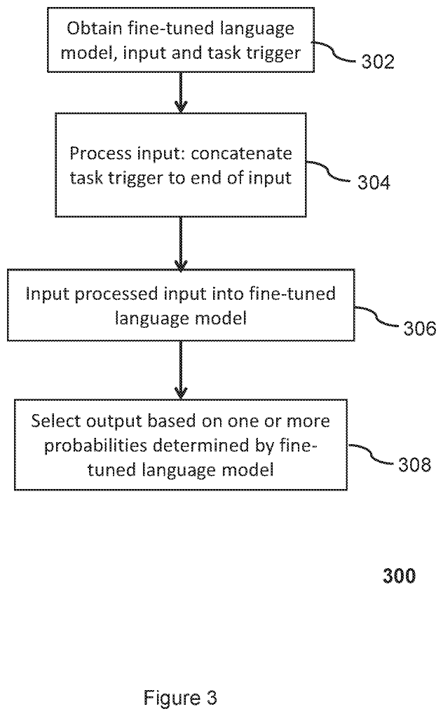

FIG. 3 shows a method for predicting an output based on an input using a language model trained using the method of FIG. 2.

The method starts by obtaining a fine-tuned language model, along with some input for processing and a task trigger representing the task to be performed 302. The language model may be accessed from storage, received from an external source, or may be obtained through training in accordance with FIG. 2. Regardless of how the language model is obtained, it is a language model that has been trained for a specific task in accordance with the methods described herein.

The task trigger may be received with the language model (e.g., from storage, from an external source or during training), may be preconfigured (e.g., where the language model has been trained for only a single task), may be received with the input, or may be input by the user or selected by the user when prompting a task to be performed. The input includes natural language data for processing in accordance with the task indicated by the task trigger.

The input is then processed by concatenating the corresponding task trigger to the end of the input to form a processed input 304. For the running example of sentiment analysis, if the new input is “I loved this”, the processed input produced would be:

“I loved this <sentiment>”

Where multiple inputs are utilized, the processed input also includes delimiter(s) between the inputs. For instance, in the multiple input inference example described above, this would form:

“The boy is walking his dog <pair> The boy is walking <inference>”

The processed input is then input into the fine-tuned language model 306. This produces a set of probabilities for the next token, as described with regard to FIG. 1. If multiple tokens are to be predicted, the language model may be applied multiple times and a prediction for the set of next tokens made (as described with regard to FIG. 1).

The output is then selected based on the one or more sets of probabilities produced by the fine-tuned language model 308. As described with regard to FIG. 1, the top prediction for what each token should be can be selected (based on probabilities for every token in the vocabulary). Alternatively, if this is too noisy and the number of possible outputs is relatively small, only the probabilities of each possible output (as judged by the model) can be considered. That is, the most probable output is selected from the set of potential outputs for the specific task, rather than selecting the most probable token from the dictionary. This can help to ensure that the output is constrained to the required set of outputs for the task at hand.

In light of the above, it can be seen that language models trained on non-specific natural language data can be easily and efficiently trained to perform specific tasks usually reserved for supervised training systems through the application of unsupervised learning on training data that has been specifically processed to encode task triggers and outputs (labels). This is achieved without any change to the architecture of the language model (or the addition of any further layers to the model) and, potentially, without any change to the unsupervised training method for the language model.

This allows general natural language characteristics learned by a generic language model to be leveraged to efficiently train a model to perform a specific task. This avoids the need to train a completely new system (e.g., based on supervised learning). Furthermore, as there are no architecture changes, there is no need for multiple different architectures to be compared in order for the best architecture to be determined.

Multiple tasks may be trained at the same time through the inclusion of multiple sets of processed training data, one set per task. In addition, as the architecture of the model remains unchanged, the model can be iteratively updated with new tasks over time without requiring a completely new system to be designed and trained. This allows efficient and simple updates to the system to add additional functionality.

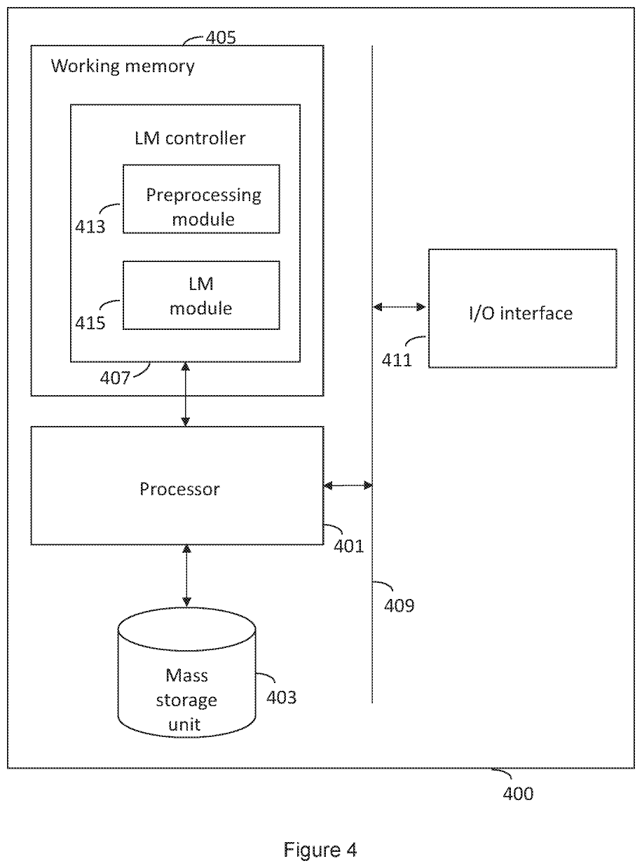

While the reader will appreciate that the above embodiments are applicable to any computing system, a typical computing system is illustrated in FIG. 4, which provides means capable of putting an embodiment, as described herein, into effect. As illustrated, the computing system 400 comprises a processor 401 coupled to a mass storage unit 403 and accessing a working memory 405. As illustrated, a language model (LM) controller 407 is represented as a software product stored in working memory 405. However, it will be appreciated that elements of the LM controller 407 may, for convenience, be stored in the mass storage unit 403.

Usual procedures for the loading of software into memory and the storage of data in the mass storage unit 403 apply. The processor 401 also accesses, via bus 409, an input/output interface 411 that is configured to receive data from and output data to an external system (e.g., an external network or a user input or output device). The input/output interface 411 may be a single component or may be divided into a separate input interface and a separate output interface.

The LM controller 407 includes a pre-processing module 413 and a language modelling (LM) module 415. The pre-processing module is configured to process inputs to prepare them for inputting into the language model (as described above). The LM module is configured to perform prediction based on the processed input. The LM controller may be configured to train the language model of the LM module in accordance with the training methods described herein.

The LM controller software 407 can be embedded in original equipment or can be provided, as a whole or in part, after manufacture. For instance, the LM controller software 407 can be introduced, as a whole, as a computer program product, which may be in the form of a download, or be introduced via a computer program storage medium, such as an optical disk. Alternatively, modifications to an existing LM controller 407 can be made by an update, or plug-in, to provide features of the above described embodiment.

The mass storage unit 403 may store the language model for access by the LM module.

The computing system 400 may be an end-user system that receives inputs from a user (e.g., via a keyboard or microphone) and determines outputs to the inputs based on the language model. Alternatively, the system may be a server that receives inputs over a network and determines corresponding outputs, which are then conveyed back to the user device.

The methods described herein provide methods for training and utilizing a generic language model to perform specific tasks usually reserved for specific models trained via supervised learning. This is achieved efficiently through the specific processing of training data to encode task triggers and outputs so that the architecture of the language model can be kept the same. This avoids extensive training (where the language model is not used) or complicated architectural changes. This also allows the model to be iteratively updated with additional tasks through repeated training based on newly processed data sets.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for training a language model to perform one or more specific natural language processing tasks, the method comprising:
obtaining a language model configured to assign probabilities to collections of words and determine a most likely set of one or more words to follow a particular input set of words;
obtaining a natural language training data set comprising training inputs and corresponding training outputs, wherein each training output represents a result of a mapping from a corresponding input via a corresponding task of one or more natural language processing tasks;
combining each training input with its corresponding training output and a task trigger representing its corresponding task to form a set of processed training inputs, wherein the combining comprises, for each training input, concatenating the training input, the task trigger representing the corresponding task and the corresponding training output to form a corresponding processed training input; and
training the language model to perform the one or more natural language processing tasks, wherein the training produces an updated language model configured to perform any one of the one or more natural language processing tasks to predict an output comprising a most likely set of one or more words to follow an input and the task trigger for the one of the one or more natural language processing tasks, wherein the training applies unsupervised learning to the set of processed training inputs to update weights of the language model.

2. The method of claim 1 wherein the training does not adjust an architecture of the language model such that the updated language model has the same architecture as the language model.

3. (canceled)

4. The method of claim 1 wherein the task trigger is concatenated to the end of the training input, and the corresponding training output is concatenated to the end of the task trigger.

5. The method of claim 1 wherein the one or more natural language tasks are one or more classification tasks and the training outputs are labels for corresponding training inputs in the natural language training data set.

6. The method of claim 1 further comprising:
training the updated language model to perform one or more further tasks, comprising:
obtaining a further training data set comprising further training inputs and corresponding further training outputs, wherein each output represents a result of a mapping from a corresponding training input via a corresponding further task of the one or more further tasks;
combining each further training input with its corresponding further training output and a further task trigger representing its corresponding further task to form a further set of processed training inputs; and
training the updated language model to perform the one or more further tasks, wherein the training produces a further updated language model configured to perform any one of the one or more further tasks to predict an output through processing of an input and the task trigger for the one of the one or more further tasks, wherein the training of the updated language model applies unsupervised learning to the further set of processed training inputs to further update weights of the updated language model.

7. The method of claim 6 wherein the one or more natural language tasks and the one or more further tasks are classification tasks that differ from each other.

8. The method of claim 1 wherein the one or more natural language tasks comprise multiple tasks.

9. The method of claim 1 wherein:
the natural language training data set comprises sets of multiple training inputs, each set of multiple training inputs having a corresponding training output representing a result of a mapping from the set of multiple training inputs via a corresponding multiple input task of the one or more natural language processing tasks;
combining each training input with its corresponding training output and a task trigger comprises, for each set of multiple training inputs, forming a delimited training input by inserting a delimiter tag between each adjoining pair of training inputs in the set of multiple training inputs and combining the delimited training input with the corresponding training output and a multiple input task trigger representing the multiple input task; and
the training produces an updated language model that is configured to perform the multiple input task to predict an output through processing of a delimited input and a multiple input task trigger, the delimited input comprising multiple inputs with a delimiter tag separating each adjoining pair of inputs.

10. The method of claim 1 wherein:
the natural language training data set comprises sets of multiple training outputs, each set of multiple training outputs representing a result of a mapping from a corresponding input via a corresponding multiple output task of the one or more natural language processing tasks;
combining each training input with its corresponding training output and a task trigger comprises, for each set of multiple training outputs, forming a delimited training output by inserting a delimiter tag between each adjoining pair of training outputs in the set of multiple training outputs and combining the delimited training output with the corresponding training input and a multiple output task trigger representing the multiple output task; and
the training produces an updated language model that is configured to perform the multiple output task to predict a delimited output through processing of an input and a multiple output task trigger, the delimited outputs comprising multiple outputs with a delimiter tag separating each adjoining pair of inputs.

11. The method of claim 1 further comprising:
receiving an input for processing by the updated language model;
obtaining a task trigger representing a task to be performed on the input;
combining the input with the task trigger to produce a processed input;
determining a prediction for an output in accordance with the task to be performed on the input by inputting the processed input into the updated language model; and
outputting the predicted output.

12. The method of claim 11 wherein determining the prediction for the output comprises:
inputting the processed input into the updated language model to obtain a set of probabilities, each probability representing a probability of a corresponding token following the processed input; and
selecting the predicted output based on the set of probabilities.

13. The method of claim 12 wherein:
the set of probabilities comprises a probability for each token in a predefined dictionary;
determining the prediction for the output further comprises extracting a subset of the set of probabilities, the subset including a probability for each of a set of expected outputs for the task; and
the predicted output is selected based on the subset.

14.-16. (canceled)

17. A natural language processing system comprising one or more processors configured to:
obtain a language model configured to assign probabilities to collections of words and determine a most likely set of one or more words to follow a particular input set of words;
obtain a natural language training data set comprising training inputs and corresponding training outputs, wherein each training output represents a result of a mapping from a corresponding input via a corresponding task of one or more natural language processing tasks;
combine each training input with its corresponding training output and a task trigger representing its corresponding task to form a set of processed training inputs, wherein the combining comprises, for each training input, concatenating the training input, the task trigger representing the corresponding task and the corresponding training output to form a corresponding processed training input; and
train the language model to perform the one or more natural language processing tasks, wherein the training produces an updated language model configured to perform any one of the one or more natural language processing tasks to predict an output comprising a most likely set of one or more words to follow an input and the task trigger for the one of the one or more natural language processing tasks, wherein the training applies unsupervised learning to the set of processed training inputs to update weights of the language model.

18. (canceled)

19. A non-transitory computer readable medium containing programming instructions that, when executed by a computer, cause the computer to:
obtain a language model configured to assign probabilities to collections of words and determine a most likely set of one or more words to follow a particular input set of words;
obtain a natural language training data set comprising training inputs and corresponding training outputs, wherein each training output represents a result of a mapping from a corresponding input via a corresponding task of one or more natural language processing tasks;
combine each training input with its corresponding training output and a task trigger representing its corresponding task to form a set of processed training inputs, wherein the combining comprises, for each training input, concatenating the training input, the task trigger representing the corresponding task and the corresponding training output to form a corresponding processed training input; and
train the language model to perform the one or more natural language processing tasks, wherein the training produces an updated language model configured to perform any one of the one or more natural language processing tasks to predict an output comprising a most likely set of one or more words to follow an input and the task trigger for the one of the one or more natural language processing tasks, wherein the training applies unsupervised learning to the set of processed training inputs to update weights of the language model.
